(19) United States
(12) Patent Application Publication
(10) Pub. No.: US 2006/0018475 A1
(43) Pub. Date: Jan. 26, 2006

(54) Kd systems with robust timing

(75) Inventors: Harry Vig, North Billerica, MA (US); Alexei Trifonov, Boston, MA (US); Liuping Chen, Malden, MA (US)

Correspondence Address: MAGIQ TECHNOLOGIES, INC, 171 MADISON AVENUE, SUITE 1300, NEW YORK, NY, 10016-5110, US

(73) Assignee: Magiq Technologies, Inc., New York, NY (US)

(21) Appl. No.: 10/532,656

(22) PCT Filed: Feb. 7, 2004
(86) PCT No.: PCT/US04/03394

§ 371 Date: Apr. 26, 2005

Related U.S. Application Data
(60) Provisional application No. 60/445,805, filed on Feb. 7, 2003.

(51) Int. Cl. H04K 1/00

(52) U.S. Cl. 380/256

(57) ABSTRACT

QKD systems having timing systems and timing method that allow for QKD to be performed in actual field conditions associated with practical commercial applications of quantum cryptography. The QKD system includes optical modems in each QKD station. Each modem has a circulator with an optical receiver and an optical transmitter coupled to it. One of the optical modems includes two phase lock loops and the other optical modem includes a phase lock loop and a transmit clock. Synchronization pulses are exchanged between the optical modems over a timing channel to synchronize the operation of the QKD system. The phase lock loops serve to lock a receive timing domain to a transmit time domain to ensure proper encoding and detection of weak quantum signals exchanged between the QKD stations.

### CLAIM OF PRIORITY

This patent application claims priority from U.S. Provisional Patent Application No. 60/445,805, filed on Feb. 7, 2003.

### TECHNICAL FIELD OF THE INVENTION

The present invention relates to quantum cryptography, and in particular relates to quantum key distribution (QKD) systems with robust timing systems and methods for performing QKD.

### BACKGROUND ART

Quantum key distribution (QKD) involves establishing a key between a sender (“Alice”) and a receiver (“Bob”) by using weak (e.g., 0.1 photon, on average) optical signals transmitted over a “quantum channel.” The security of the key distribution is based on the quantum mechanical principal that any measurement of a quantum system in an unknown state will modify its state. As a consequence, an eavesdropper (“Eve”) that attempts to intercept or otherwise measure the quantum signal will inherently introduce errors into the transmitted signals, thereby revealing her presence.

The general principles of quantum cryptography were first set forth by Bennett and Brassard in their article “Quantum Cryptography: Public key distribution and coin tossing,” Proceedings of the International Conference on Computers, Systems and Signal Processing, Bangalore, India, 1984, pp. 175-179 (IEEE, New York, 1984). A specific QKD system is described in U.S. Pat. No. 5,307,410 to Bennet (the '410 patent).

The Bennett-Brassard article and the '410 patent each describe a so-called “one-way” QKD system wherein Alice randomly encodes the polarization of single photons, and Bob randomly measures the polarization of the photons. The one-way system described in the '410 patent is based on a two-part optical fiber Mach-Zehnder interferometer. Respective parts of the interferometer are accessible by Alice and Bob so that each can control the phase of the interferometer. The signals (pulses) sent from Alice to Bob are time-multiplexed and follow different paths. The '410 patent discloses a separate “timing channel” to convey timing signals from a sender to a receiver. However, the timing systems and methods necessary for practical operation the system are not disclosed in the '410 patent.

U.S. Pat. No. 6,438,234 to Gisin (the '234 patent), which patent is incorporated herein by reference, discloses a so-called “two-way” QKD system that is autocompensated for polarization and thermal variations.

While the two-way QKD system of the '234 patent has certain advantages over a one-way system, this system is like the '410 system in that it cannot operate without a timing system that synchronizes the sending and receiving of optical pulses. However, as with the '410 patent, such a timing system is not disclosed in the '234 patent.

U.S. Pat. No. 5,675,648 (the '648 patent) to Townsend discloses a QKD system that uses a “common transmission medium” for the quantum and public channels. The '648 patent includes a description of a timing system that employs a system clock to avoid timing errors in transmitting and detecting a weak optical pulse. The timing function is performed during calibration of the interferometer. With reference to FIG. 4 of the '648 patent, the amplified output from the public channel detector is input into a clock registration module. This module contains an electronic filter that produces an oscillating signal at the pulse repetition frequency which is used to lock a local oscillator to the optical source or master clock frequency. This local oscillator is then used to provide the timing information required by the receiver during the quantum transmission stage of the protocol. Each time the transmitted system is recalibrated via the public channel, the local oscillator is re-timed to avoid the accumulation of any timing errors.

Thus, the timing system of the '648 patent operates in a switched mode rather than in a continuous mode, which is not an efficient way to maintain timing synchronization and control jitter in the timing signal. Also, the system is designed so that the timing is controlled by only one of the stations. Further, the system as designed is not programmable to operate in the variety of operational modes needed in the field. These and other shortcomings of the '648 Patent system are disadvantageous in a commercially viable QKD system.

Accordingly, there is a need for robust timing systems and methods that allow for the manufacture and deployment of commercially viable QKD systems.

### BRIEF DESCRIPTION OF THE DRAWINGS

FIG. 1A is a high-level schematic diagram of the symmetric QKD system of the present invention, showing the quantum, classical (data) and timing channels connecting Alice and Bob, along with each QKD station (Bob and Alice) including a quantum channel optics layer (“quantum transceiver”), a public data transceiver, an optical modem, a random number generator unit, and a controller;

FIG. 1B is a schematic diagram similar to FIG. 1A, but that includes a WDM in each QKD station and a single communication link for the quantum, data and timing channels;

FIG. 2A is a schematic diagram of an example embodiment of the quantum transceiver for Alice for a one-way QKD system;

FIG. 2B is a schematic diagram of an example embodiment of the quantum transceiver for Bob for a one-way QKD system for use with the quantum transceiver of FIG. 2A;

FIG. 2C is a schematic diagram of an example embodiment of the quantum transceiver for Bob for a two-way QKD system;

FIG. 2D is a schematic diagram of an example embodiment of the quantum transceiver for Alice for a two-way QKD system for use with the quantum transceiver of FIG. 2C;

FIG. 2E is a schematic diagram of an example embodiment of an optical time-domain reflectometer (OTDR) that uses the optical pulse transmitter and quantum transceiver of FIG. 2C;

FIG. 3A is a schematic diagram of the optical modems of the timing system of FIG. 1A, wherein each optical modem has optical circulator, an optical transmitter, an optical receiver and associated phase lock loops, and illustrating the connections between the receive time domains (RTDs) and the transmit time domains (TTDs), as well as the sync signals that travel in each direction over the timing channel connecting the modems;

FIG. 3B is a schematic diagram similar to FIG. 3A but illustrating another example embodiment of the modems;

FIG. 3C is a close-up schematic diagram of a portion of the optical modem for Bob as it is used in OTDR mode;

FIG. 3D is a close-up schematic diagram of the phase lock loops connected to an optical receiver in the optical modem;

FIG. 4 is a timing diagram illustrating the waveform of the sync signals sent across the optical modem of the timing system, wherein the sync signal includes sync pulses that include timing information as well as synchronization and control data;

FIG. 5A is a schematic diagram of a clock-based digital pulse generator (DPG) implemented in the FPGA of the controller as used to generate trigger pulses for the drivers;

FIG. 5B is a schematic diagram of an example embodiment of a pulse timing generator used in FIG. 5A and illustrates how the circuit of FIG. 5A is grouped and duplicated for each timing signal;

FIG. 6 is a schematic diagram of an example embodiment of an RNG unit that includes multiple data sources and a data source selector coupled to a modulator driver;

FIG. 7A is a schematic diagram of a fine delay block placed after the output of each digital comparator to allow the pulses outputted therefrom to be adjusted in finer steps, and to allow adjustment of output pulse width;

FIG. 7B is an electrical signal diagram that shows the relative timing of the pulses outputted from the digital comparator, the delay blocks, the logic gate and the fine delay block;

FIG. 8 is a schematic diagram of an example QKD system suitable for applying the timing systems and methods of the present invention.

### DETAILED DESCRIPTION OF THE INVENTION

The present invention relates to quantum cryptography, and in particular relates to QKD systems with robust timing systems and methods for performing QKD. QKD systems have industrial utility only to the extent that they can operate and be adjusted in the field and not just in a laboratory or other artificial environments. To this end, it is critical that a commercially viable QKD system be designed to operate in combination with a robust timing system that allows for the synchronous operation of the various elements of the QKD system. In particular, the QKD system needs to operate in the field so that weak quantum signals can be generated and detected in order to exchange a secure key in a variety of real-world environments.

An overview of various embodiments of QKD systems according to the present invention is first set forth. This is followed by a more detailed explanation of the structure and operation of example timing systems corresponding to the various modes of operation of the example QKD systems.

In the discussion below, “randomly modulating” means randomly selecting a modulation from a select and finite group of possible modulations, such as two or four select phase modulations. Also, “encoding” means imparting a random phase or polarization to a quantum signal.

In addition, the term “quantum transceiver” is used to describe the optical layer used to transmit, receive, or both transmit and receive quantum signals over the quantum channel. Further, “quantum signals” are signals that travel over the quantum channel between quantum transceivers. One skilled in the art will understand that in certain instances the quantum signals are relatively strong, while at other times the quantum signals are weak, i.e., less than a photon per pulse, on average.

I. QKD System Overview

A. Multi Communication Link Embodiment

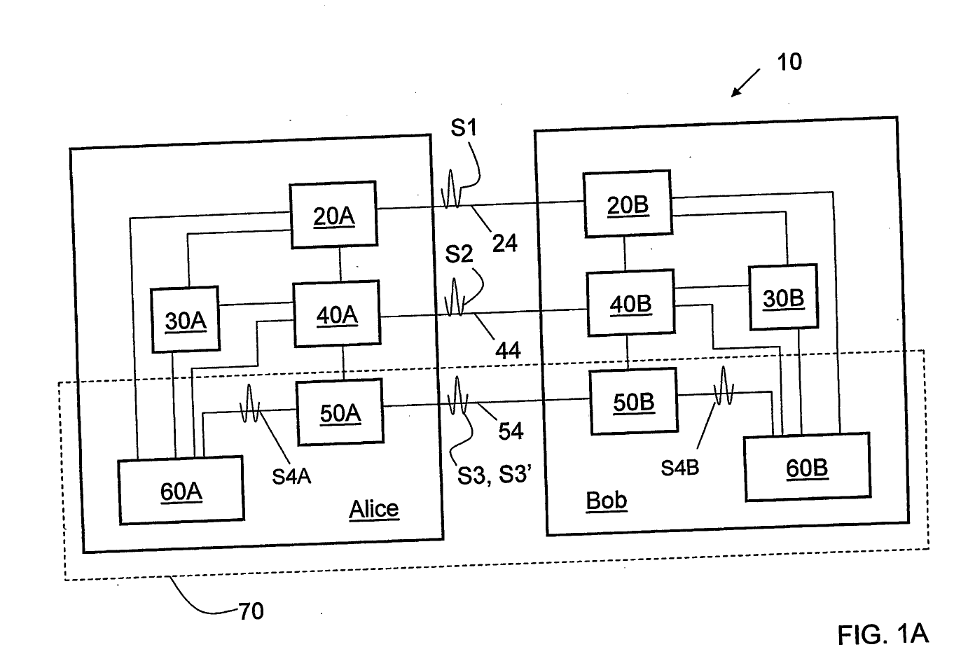

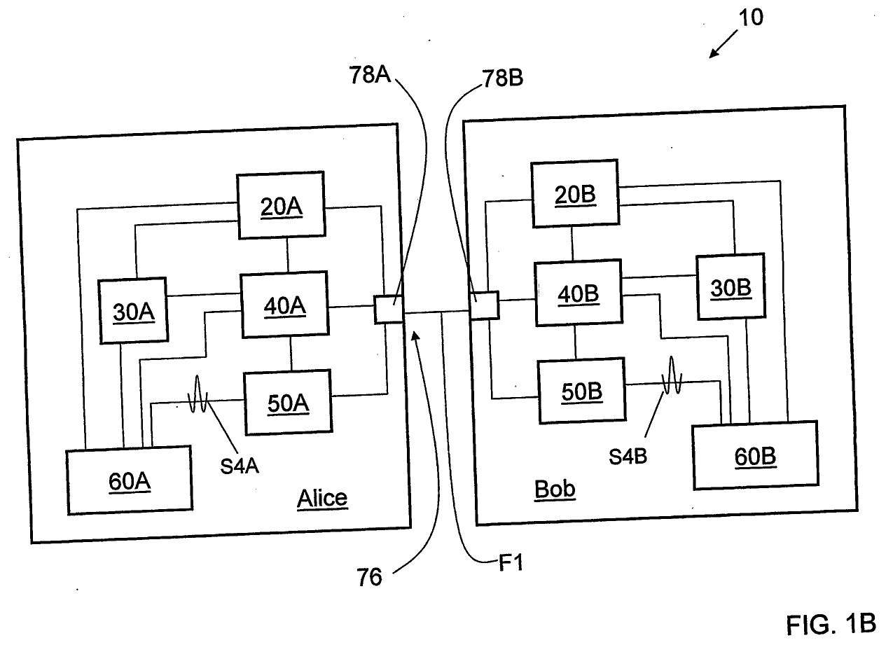

FIG. 1A is a high-level schematic diagram of a quantum key distribution (QKD) system 10 according to the present invention. System 10 includes two QKD stations, referred to as “Alice” and “Bob.” Alice includes a quantum channel optics layer (“quantum transceiver”) 20A for preparing, transmitting and/or receiving a quantum signal S1 sent to or receive from Bob over a quantum channel 24, which is coupled to Bob. Alice also includes a random number generator (RNG) unit 30A coupled to quantum transceiver 20A. RNG unit 30A provides random numbers to quantum transceiver 20A so that it can randomly set either the polarization or phase of quantum signal S1 based on a select set of polarizations or phases.

Alice also includes a public data transceiver (PDT) 40A coupled to a classical (data) channel 44, which is coupled to Bob. PDT 40A is adapted to acquire and process classical signals S2 used to publicly transmit and receive data (e.g., encrypted messages) between Alice and Bob. PDT 40A is coupled to RNG unit 30A and to quantum transceiver 20A.

Alice also includes an optical modem unit 50A coupled to a timing channel 54, which is also coupled to Bob. Optical modem unit 50A is adapted to transmit and receive optical signals S3 sent over timing channel 54 necessary for carrying out the timing operations, described below, and necessary for QKD system 10 to function properly.

Alice further includes a controller 60A which is coupled to quantum transceiver 20A, RNG unit 30A, PDT 40A and optical modem unit 50A. Controller 60A is adapted to coordinate the timing of operation of the above-mentioned components, as described below.

The basic constitution of Bob corresponds identically to that of Alice, i.e., Bob includes a quantum transceiver 20B, RNG unit 30B, PDT 40B, optical modem unit 50B and a controller 60B, all arrange essentially as in Alice. Quantum transceiver 20B, PDT 40B and optical modem unit 50B are coupled to their respective counterparts quantum transceiver 20A, PDT 40A and optical modem unit 50A in Alice, via quantum channel 24, classical channel 44 and timing channel 54, respectively. Controllers 60A and 60B, optical modem units 50A and 50B, and timing channel 54 are collectively referred to herein as the timing system” 70 for system 10. The symmetry between Bob and Alice has great industrial utility in that it makes it easier to produce a QKD system by having the same layout for each QKD station. In particular, essentially the same circuit boards can be used in Bob and Alice, with the circuit boards being programmable to operate in a number of different modes (e.g., timing controlled by either Bob or Alice, OTD operation as explained below, etc.).

With continuing reference to FIG. 1A, in the operation of system 10, optical timing signals S3 and S3′ are exchanged between controllers 60A and 60B over timing channel 54. The optical timing signals S3 and S3′ are processed via optical modem units 50A and 50B, which convert the optical timing signals into corresponding electrical timing signals S4A and S4B, and vice versa.

B. Double and Single Communication Link Embodiments

In the example embodiment of QKD system 10 illustrated in FIG. 1A, all three channels 24, 44 and 54 are shown as using different physical communication links—for example, a first optical fiber for the quantum channel 24, a second optical fiber timing channel 54, and an Ethernet channel or fiber optic channel or single-wavelength fiber optic channel for the classical data channel 44. In such a case, quantum channel 24 and timing channel 54 are synchronous channels, while classical data communication channel can be an asynchronous or a synchronous channel.

In the example embodiment of QKD system 10 of FIG. 1B, the various communication channels 24, 44 and 54 are optically and/or electronically multiplexed into a single channel 76. For example, as shown in FIG. 1B, the optical channels can be combined into a single optical F1 using respective wavelength-division multiplexers (WDMs) 78A and 78B at the output ends of Alice and Bob.

By way of example, classical data channel 44 and timing channel 54 are multiplexed into one electrical channel first and then sent through one optical channel, which can be separate single-wavelength optical fiber, and the quantum channel 24 is sent through a separate dedicated optical fiber. This example embodiment is well-suited for the situation when the quantum channel needs to be substantially noise-free, i.e., substantially free from back-scattering or back-reflections that can arise, for example, from Raman and Rayleigh scattering, or from reflections from fiber imperfections and/or splices.

C. Example One-Way Quantum Transceiver

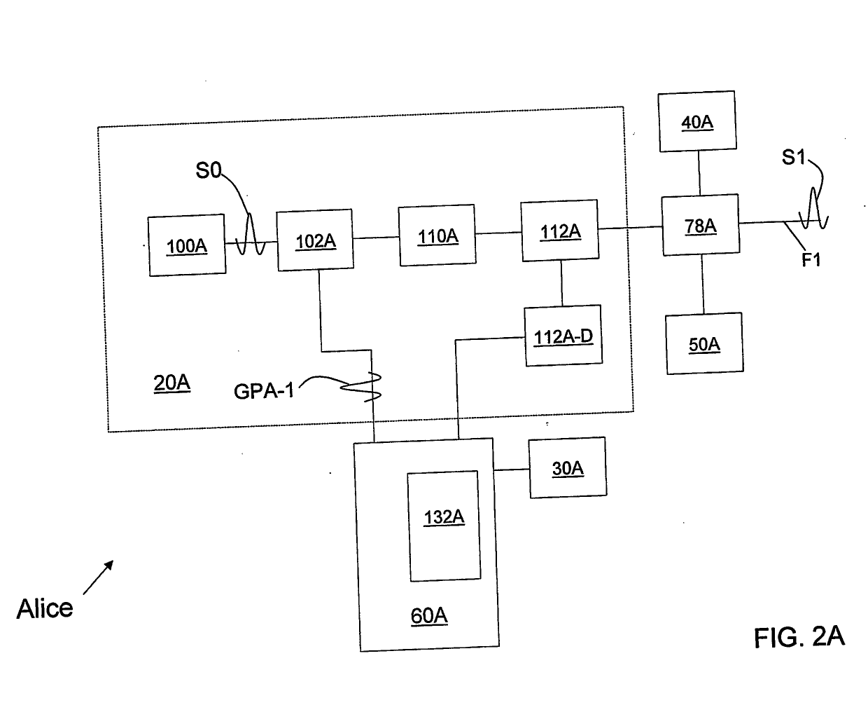

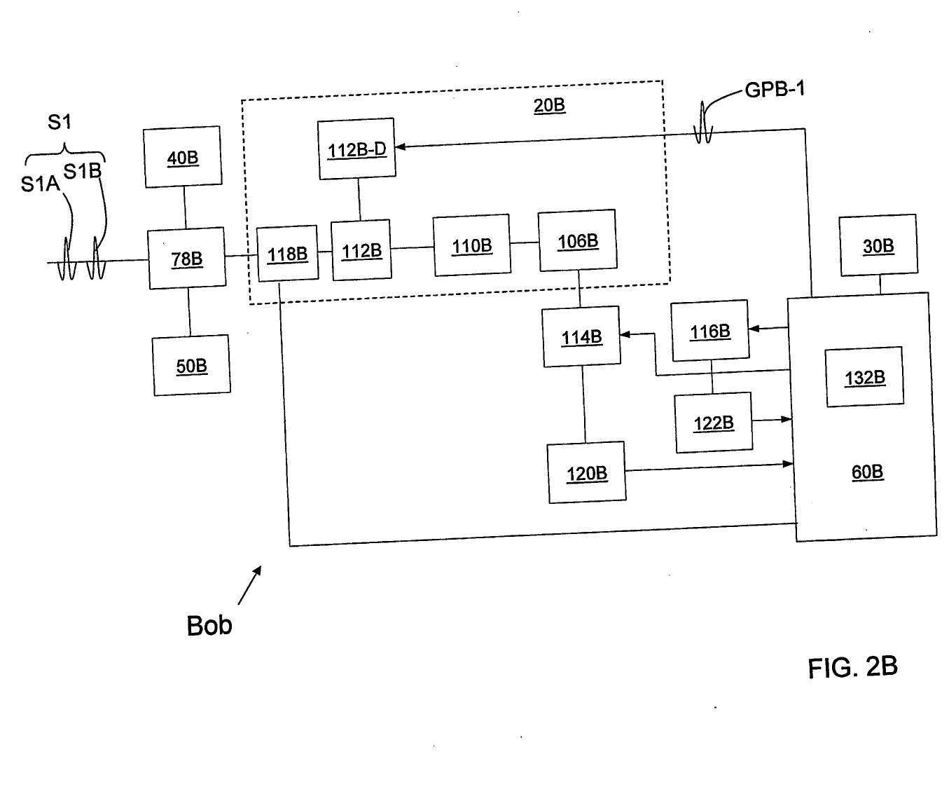

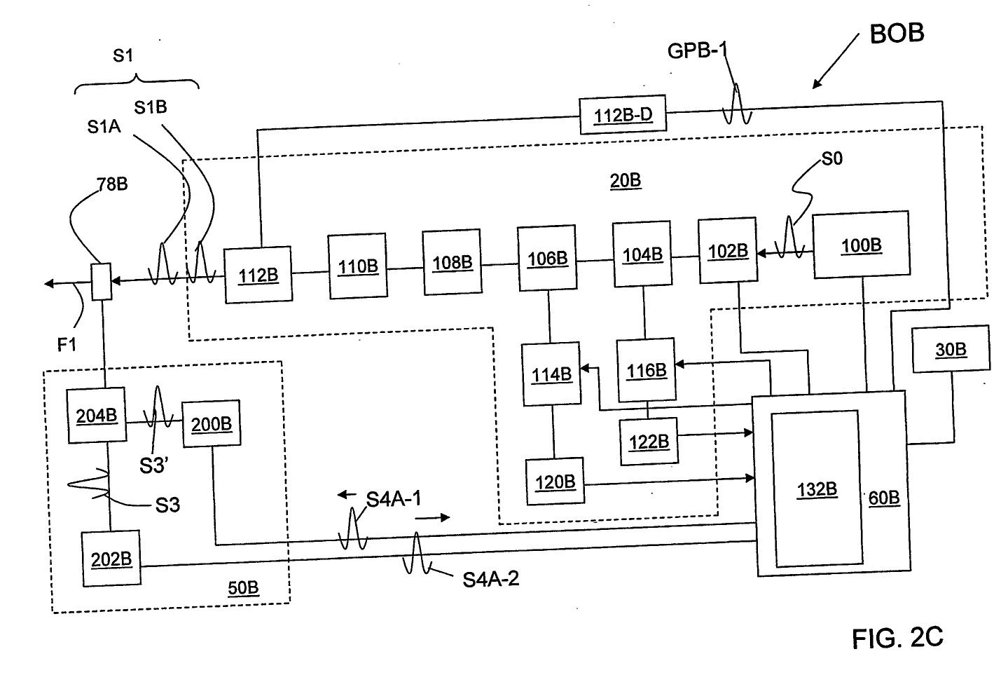

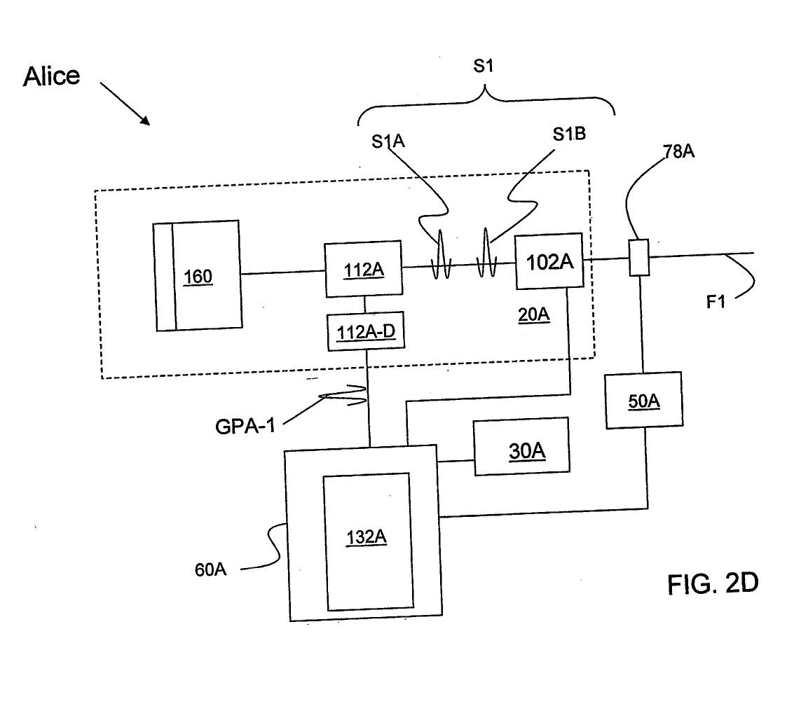

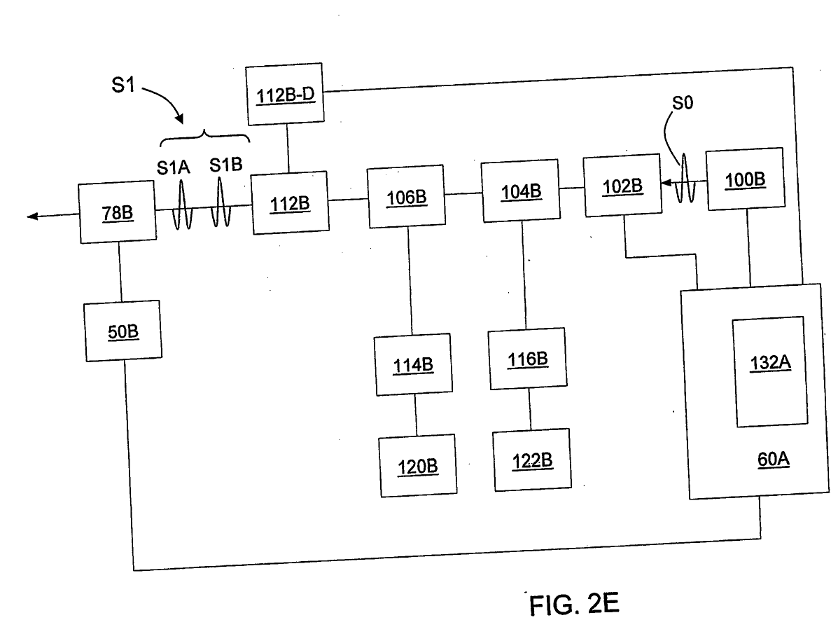

FIG. 2A is a schematic diagram of an example embodiment of Alice's quantum transceiver 20A, along with Alice's other components, for use in combination with the example embodiment of Bob and his transceiver 20B, illustrated in FIG. 2B described below.

Alice's quantum transceiver 20A includes a laser source 100A, such as a 1.5 μm laser, for generating an initial photon pulse signal S0. In an example embodiment, signal S0 includes one or more light pulses each having hundreds or thousands of photons and having a temporal width of about 400 picoseconds (ps). Quantum transceiver 20A also includes, in order from the laser source, a variable optical attenuator (VOA) 102A, an optical delay 110A, and a phase modulator 112A. VOA 102 can also be located downstream of phase modulator 112A or elsewhere in the system. VOA 102 is used to control the intensity of the optical pulse signal S0 to form a weak quantum signal S1, i.e., a signal having, on average, less than a photon, and preferably about 0.1 photon or less. This weak quantum signal S1 is sent to Bob over the quantum channel 24 (FIG. 1A).

With continuing reference to FIG. 2A, Alice's RNG unit 30A is also coupled to controller 60A, which is coupled to a phase modulator driver 112A-D, which in turn is coupled to a phase modulator 112A. Controller 60A is also coupled to VOA 102A to control the amount of attenuation in creating quantum signal S1 from signal S0. Controller 60 also includes a field programmable gate array (FPGA) 132A.

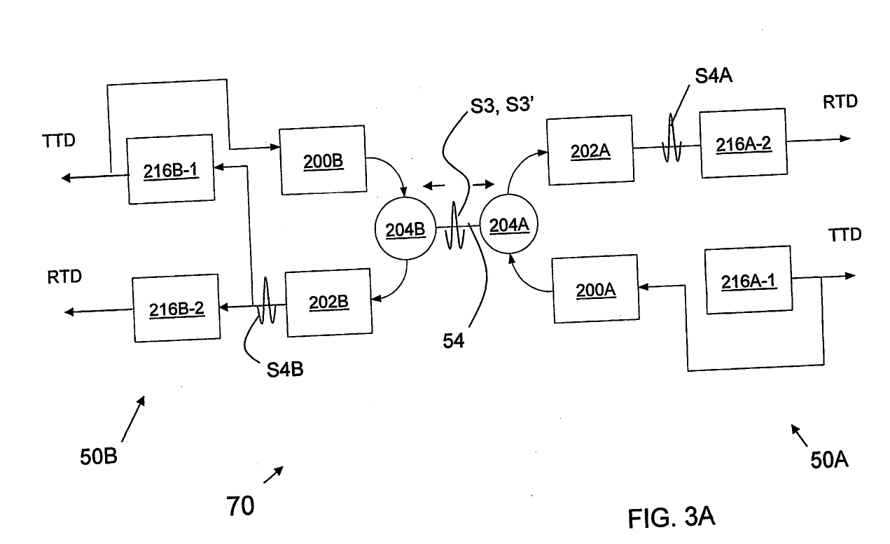

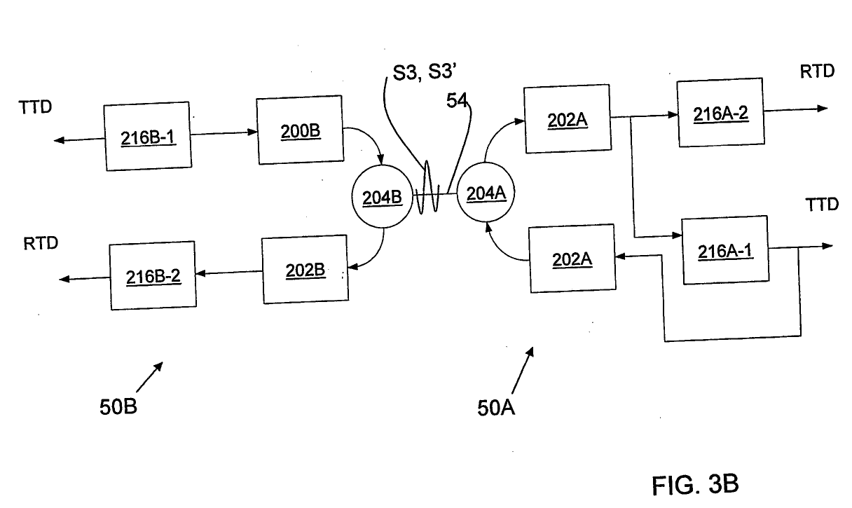

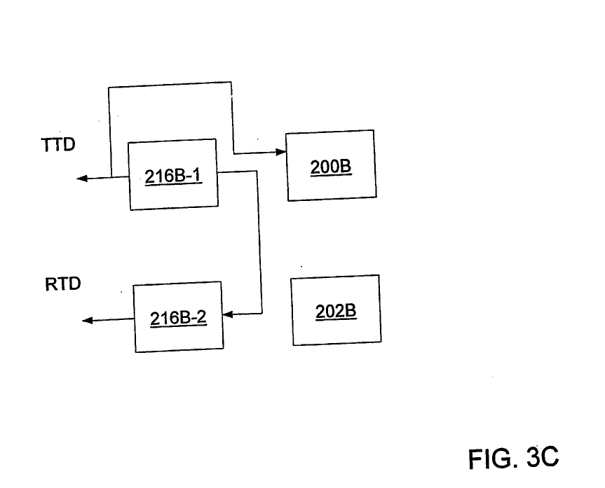

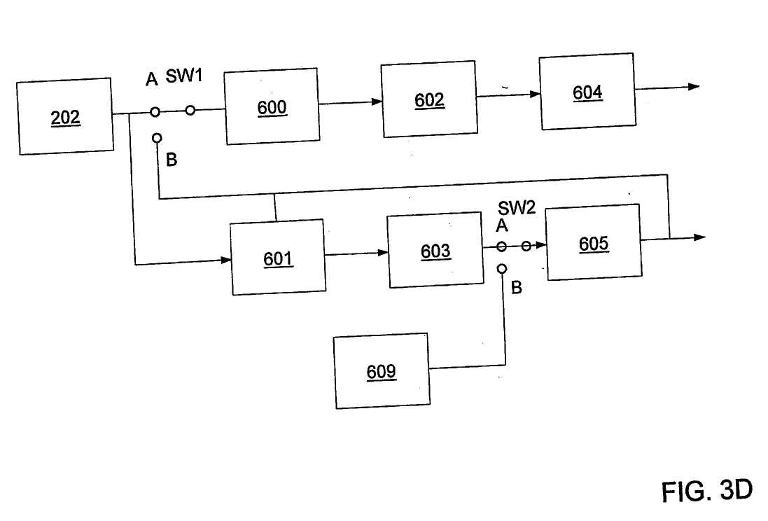

Also illustrated in FIG. 2A is optical modem unit 50A connected to optional WDM 78A. Optical modem unit 50A is as shown in greater detail in FIG. 2C, and explained in greater detail below in connection with FIGS. 3A through 3D. The optical modem unit 50A is an integral part of the timing system used for data communication and clock synchronization between Alice and Bob.

Also illustrated in FIG. 2A is the connection of PDT 40A to WDM 78A. PDT 40A encrypts data associated with the user and public discussion layer and transmits optically on the fiber F1 via WDM 78A. PDT 40A also receives data split off by the WDM 78A, and decrypts the data.

D. Example One-Way Quantum Transceiver

FIG. 2B is a schematic diagram of an example embodiment of Bob and his quantum transceiver 20B as used in a one-way QKD system in conjunction with Alice's quantum transceiver 20A as shown in FIG. 2A. In such a system, Alice's transceiver 20A acts as a transmitter, and Bob's quantum transceiver 20B acts as a receiver. Bob's quantum transceiver 20B includes an optical delay 110B and a phase modulator 112B. The quantum transceiver also includes a first single-photon detector 114B coupled to polarization compensator 118B, a PM beamsplitter 106B, and a second single-photon detector 116B coupled to PM circulator 104B. Single-photon detectors 114B and 116B are respectively coupled to discriminators 120B and 122B, which are coupled to controller 60B. RNG unit 30B is also coupled to controller 60B, which is coupled to a phase modulator driver 112B-D, which in turn is coupled to a phase modulator 112B. Controller 60B is also coupled to polarization compensator 118B to correct polarization errors caused by the environmental changes in the transmission medium. Controller 60 also includes a field programmable gate array (FPGA) 132B.

Also illustrated in FIG. 2B is optical modem unit 50B and PDT 40B each connected to a WDM 78B similar to that illustrated in FIG. 2A in connection with Alice.

E. Example Two-Way Quantum Transceiver

FIG. 2C is a schematic diagram of an example embodiment of Bob and his quantum transceiver 20B as used in a two-way QKD system. For a two-way QKD system, a classical (i.e., non-quantum) optical pulse transmitter is required to transmit light from the receiver to the quantum transceiver (which in this case is Alice).

Quantum transceiver 20B includes a laser source 100B, such as a 1.5 μm laser, for generating an initial photon pulse signal SO consisting of one or more pulses of light each having hundreds or thousands of photons, and having a temporal pulse width of 400 ps. Quantum transceiver 20B also includes, in order from the laser source, a variable optical attenuator (VOA) 102B to control the intensity of the optical pulse signal S0 to create quantum signal S1, which is ultimately introduced into the quantum channel 24 (FIG. 1A). Quantum transceiver 20B also includes a polarization-maintaining (PM) circulator 104B, a PM beamsplitter 106B, a 45° polarizer 108B, an optical delay 110B, and a phase modulator 112B. The quantum transceiver 20B also includes a first single-photon detector 114B coupled to PM beamsplitter 106B, and a second single-photon detector 116B coupled to PM circulator 104B. Single-photon detectors 114B and 116B are respectively coupled to discriminators 120B and 122B, which are coupled to controller 60B.

RNG unit 30B is also coupled to controller 60B, which is coupled to a phase modulator driver 112B-D, which in turn is coupled to a phase modulator 112B. Controller 60B is also coupled to VOA 102B to control the amount of attenuation provided by VOA 102 in attenuating photon signal SO to create the quantum signal S1. Controller 60 also includes a field programmable gate array (FPGA) 132B.

Also illustrated in FIG. 2C is optical modem unit 50B connected to optional WDM 78B. Optical modem unit 50B includes a timing/synch laser (i.e., an optical transmitter) 200B (e.g., operating at 1.3 μm) and a timing/synch detector (i.e., an optical receiver) 202B both coupled to a circulator 204B. Laser 200B and detector 202B are coupled to FPGA 132B in controller 60B, as explained in greater detail below in connection with FIG. 3A.

F. Example Two-Way Quantum Transceiver

FIG. 2D is a schematic diagram of an example embodiment of Alice's quantum transceiver 20A as used in combination with the example embodiment of Bob's transmitter as illustrated in FIG. 2C and discussed immediately above. Alice's quantum transceiver 20A includes WDM 78A, a phase modulator 112A coupled to a phase modulator driver 112A-D, and a Faraday mirror 160 arranged optically downstream of the phase modulator. RNG unit 30A is coupled to controller 60A, which is coupled to phase modulator driver 112A-D. Also shown schematically in FIG. 2D is optical modem unit 50A, which in an example embodiment similar to optical modem unit 50B described above. Optical modem unit 50A is coupled to WDM 78A and to controller 60A. Controller 60 also includes an FPGA 132A.

G. Example OTDR Function With Two-Way Quantum Transceiver

An example embodiment of the present invention includes a system for performing optical time domain reflectometry (OTDR). FIG. 2E is a schematic diagram similar to Bob's quantum transceiver 20B of FIG. 2C, but that omits components not needed to perform OTDR functions.

The initial optical pulse signal SO is generated by laser 100B and passes through VOA 102B, the polarization-maintaining (PM) circulator 104B, a PM beamsplitter 106B, phase modulator 112B, and WDM 78B, and into the fiber F1 as quantum signal S1. Here, quantum signal S1 is a relatively strong signal as is needed for performing OTDR.

A portion of quantum signal S1 is reflected back from a reflection point RP1 in fiber F1. Reflection point RP1 may arise from the presence of an element added to optical fiber F1, such as an optical tap placed by eavesdropper Eve between Bob and Alice, or from some other source of scattering or reflection in the fiber. Light reflecting from reflection point P1 passes back to Bob through WDM 78B. This light then passes through phase modulator 112B and PM beamsplitter 106B, where it is split into two orthogonal polarizations. The light continues to one of two single-photon detectors 114B and 116B coupled to discriminator 120B and 122B, respectively.

Single-photon detectors 114B and 116B and discriminators 120B and 122B are coupled to controller 60B. Single-photon detectors 114B and 116B can be changed to operate in linear mode. Discriminators 120B and 122B can be changed to operate in proportional digital data mode to measure higher levels of light with high resolution.

Controller 60B is coupled to VOA 102B to control the output light intensity of the OTDR, and to optical modem 50B. The operation of optical modem 50B in OTDR mode is discussed below in connection with FIG. 3C.

H. General Operation of the Example One-Way QKD System

With reference again to FIG. 2A, laser source 100A emits an initial light pulse signal S0. Light pulse S0 then travels through VOA 102A, which attenuates the pulses to a desired level, e.g., from hundreds or thousands of photons, to a level such that the final quantum signal S1 introduced into the quantum channel has an intensity below a single photon, on average. The attenuated light pulse signal S0 then travel through an optical delay 110A which splits signal S0 into two orthogonally polarized light pulses S1A and S1B.

Pulses S1A and S1B then pass through phase modulator 102A. At this point, controller 60A sends a gating pulse GPA-1 to phase modulator driver 102A-D. Gating pulse GPA-1 is timed so that phase modulator driver 102A-D causes phase modulator 102A to randomly modulate the phase one of the S1A and S1B (say, S1B). The phase modulation applied is chosen randomly based on random numbers provided by RNG unit 30A from a set of phase modulations. The light pulses then pass to WDM 78A and travel to Bob as optical signal S1.

In the example embodiment of FIG. 2B, the pulses travel to Bob by traversing optical F1, which carries the quantum channel 24, the public channel 44 and the timing channel 54. In the example embodiment of FIG. 1A, these channels are shown as being separate.

In an example embodiment, data on the public (data) channel 44 is transmitted and received by public data transceiver PDT 40B, which can be transmitted via a commonly available commercial optical transmitter with suitable wavelength to be combined by WDM 78A at Alice. Also, optical modem 50A transmits timing information from Alice's quantum transceiver 20A to Bob's quantum transceiver 20B relating to the transmission of pulses S1A and S1B, as explained in greater detail below.

With continuing reference to FIG. 2B, the optical pulses S1A and S1B of quantum signal S1 arrive at Bob through WDM 78B and pass through polarization compensator 118B and phase modulator 112B. Controller 60B, based on information received from Alice relating to the generation and transmission of pulses S1A and S1B, sends a gating pulse GPB-1 to phase modulator driver 112B-D timed so that it causes the phase modulator 112B to modulate the remaining unmodulated pulse (in this case, pulse S1A). The phase modulation is randomly selected based on random numbers provided by RNG unit 30A from a select number of phase-modulations.

The phase-modulated pulses S1A and S1B then enter optical delay 110B, where they are combined and interfere with one another. The recombined pulse is then detected at single-photon detector 114B or 116B, depending on the relative phases imparted to the pulses. In response, single-photon detector 114B or 116B generates an electrical signal that passes to the respective discriminator 120B or 122B and back to controller 60B. The timing coordination and synchronization of the gating pulses and other signals used to coordinate the operation of the various elements in the QKD system is discussed below.

Once a desired number of quantum pulses SI are exchanged between Bob and Alice, a shared key is derived using known techniques. For example, by Alice and Bob publicly compare the basis of their measurements (e.g., via public channel 44) and only keep the measurements (bits) corresponding to the same measurement basis. This forms a sifted key. They then choose a subset of the remaining bits to test for the presence of an eavesdropper (Eve) and then discard these bits.

The act of eavesdropping on optical path F1 by Eve intercepting or otherwise attempting to measure the weak optical pulses being transmitted between Bob and Alice will necessarily introduce errors in the key due to the quantum nature of the photons being exchanged. If there are no errors in the sifted key due to the presence of an eavesdropper Eve, then the transmission is considered secure, and the quantum key is established.

I. General Operation of the Example Two-Way QKD System

The present invention applies to a two-way autocompensated system as well. Thus, with reference again to FIG. 2C and Bob's quantum transceiver shown therein, laser source 100B emits initial light pulse S0. Light pulse S0 travels through VOA 102B, which reduces the intensity of the initial light pulses so that they each have hundreds or thousands of photons. Attenuated light signal S0 passes through PM circulator 104B and PM beamsplitter 106B, and is polarized at 45° by polarizer 108B. Light pulse S0 then proceeds to optical delay 108, which forms two orthogonally polarized pulses S1A and S1B (making up quantum signal S1) from light pulse S0. In this embodiment, quantum signal S1 heading out from Bob are not quantum signals per se, i.e., they are not optical pulses having a less than a single photon on average. Rather, they are relatively strong pulses having, for example, hundreds or thousands of photons per pulse. However, as mentioned above, it is still referred to as a “quantum signal” herein because it is transmitted over the quantum channel.

Pulses S1A and S1B then pass through WDM 78B and travel over an optical fiber F1 to Alice. In the example embodiments of FIGS. 2C and 2D, optical fiber F1 carries the quantum channel 24, the public channel 44 and the timing channel 54. Data on the public channel 44 can be transmitted on any commonly available commercial optical transmitter with suitable wavelength to be combined by a WDM. Optical Modem 50A transmits timing information from Alice 20A to Bob 20B, as explained in more detail in a later section.

With reference again to FIG. 2D and Alice's transceiver 20A shown therein, the optical pulses S1A and S1B arrive at Alice through WDM 78A and pass through phase modulator 112A to Faraday mirror 160. Faraday mirror 160 reflects pulses S1A and S1B and rotates the polarization of each pulse by 90°. Controller 60A then sends a gating pulse GPA-1 to phase modulator driver 112A-D. Gating pulse GPA-1 is timed so that is causes phase modulator 112A to randomly modulate one of pulses S1A and S1B (say, S1A) from a set of phase-modulations based on random numbers supplied by RNG unit 30A. Pulses S1A and S1B are attenuated to down to single-photon level or below on average by VOA 102A.

With reference again also to FIG. 2C, the attenuated (i.e., weak) quantum pulses S1A and S1B then travel back to Bob over optical fiber F1, where controller 60B generates a timing signal in the form of gating pulse GP1-B timed to phase-modulate the remaining unmodulated pulse (pulse S1B) in the manner described above.

The quantum pulses then enter optical delay 110B, where they are combined and interfere with one another. The recombined pulse is then detected at single-photon detector 114B or 116B, depending on the relative phases imparted to the pulses. The single-photon detector that detects the recombined pulse generates an electrical signal that passes to the respective discriminator 120B or 122B and back to controller 60B. The timing coordination and synchronization of the gating pulses and other signals used to coordinate the operation of the various elements in the QKD system is discussed below.

Once a desired number of pulses are exchanged between Bob and Alice, a shared key is derived using known techniques. For example, by Alice and Bob publicly comparing the basis of their measurements (e.g., via public channel 44) and only keeping the measurements (bits) corresponding to the same measurement basis. This forms a sifted key. They then choose a subset of the remaining bits to test for the presence of an eavesdropper (Eve) and then discard these bits. The act of eavesdropping on optical fiber F1 by Eve intercepting or otherwise attempting to measure the weak optical pulses being transmitted between Bob and Alice will necessarily introduce errors in the key due to the quantum nature of the photons being exchanged. If there are no errors in the sifted key due to the presence of an eavesdropper Eve, then the transmission is considered secure, and the quantum key is established.

J. General Operation of the Example OTDR Mode Using Two-Way QKD System

With reference again to FIG. 2E, an initial optical pulse signal S0 is generated by laser 100B. The width of the signal S0 can be varied from about 400 ps to about 10 ns and the attenuation of the VOA 102B can be reduced to near zero to generate a strong optical pulse.

The pulse S0 travels through the polarization-maintaining (PM) circulator 104B, a PM beamsplitter 106B, phase modulator 112B (without modulation), and WDM 78B, and into the fiber F1. Light pulse S0 travels down the fiber F1 and portions S1B the original pulse S0 return to due to scattering and reflections, generally indicated by one or more reflection points RP1. Various pulses S1B return from the fiber, varying in amplitude and time delay according to the amount of scattering and reflection and the round trip distance traveled by the returning signals.

Light pulses S1B travels back through WDM 78B, phase modulator 112B, and PM beamsplitter 106B. The quantum transceiver 20B includes a first single-photon detector 114B coupled to PM beamsplitter 106B, and a second single-photon detector 116B coupled to PM circulator 104B. Single-photon detectors 114B and 116B are respectively coupled to discriminators 120B and 122B, which are coupled to controller 60B. Single-photon detectors 114B and 116B can be changed to operate in linear mode. Discriminators 120B and 122B can be changed in mode to give proportional digital data to measure levels of light beyond single photons.

Controller 60B is coupled to detectors 114B and 116B, discriminators 120B and 1220B, and VOA 102B to control the amount of light in signal S0, which serves to vary the working range of the OTDR. The controller measures the light level and time delay between the outgoing pulse S0 and returning pulses S1B to determine the characteristics of the fiber, e.g., the location of reflection points RP1.

Optical modem 50B is used to connect the transmit portion of the OTDR, starting with laser 100B, to the receiver portion, including discriminators 120B and 122B.

II. Timing System

The above description of the various embodiments of the operation of QKD system 10 presupposes that a timing system is in place to coordinate the sending of the initial quantum signal pulse S0, the modulation of pulse S1A by Alice's phase modulator 112A, the modulation of pulse S1B by Bob's phase modulator 112B (thereby forming quantum signal S1), and the detection of the combined pulse at either of the single photon detectors 114B and 116B.

Further, the above description presupposes that the timing system can account for variations (e.g., drifts and jitter) in the timing signals, and account for variations in the arrival times of the quantum signals.

The timing system 70 (FIG. 1A) is adapted to accomplish the above. FIGS. 3A through 3C are detailed schematic diagrams of an example embodiment of the timing system 70 of FIG. 1A, for the specific cases of a one-way QKD system (FIG. 3A), a two-way QKD system (FIG. 3B), and an OTDR (FIG. 3C).

A. Example Timing Operation of One-Way Quantum Transceiver

FIG. 3A is a schematic diagram of an example embodiment of the timing system 70 of FIG. 1A that uses two optical circulators and further illustrates the controller clock domains and their connections to the phase lock loops (PLLs) and clocks.

With reference to FIG. 3A, system 70 includes at Alice a circulator 204B coupled at one port to an optical transmitter 200A and at another port to an optical receiver 202A. Optical receiver 202A is coupled to a receive PLL 216A-2, which is coupled to the receive time domain RTD. Optical transmitter 200A is coupled to a fixed clock oscillator (“transmit OSC”) 216A-1.

Likewise, system 70 includes at Bob an arrangement similar to that at Alice describe immediately above, but with a circulator 204B, optical transmitter 200B, an optical receiver 202B, an transmit PLL 216B-1 and receive PLL 216B-2. Note that at Bob the optical receiver 202B is coupled to both the receive PLL 216B-2 and the transmit PLL 216B-1.

Transmit OSC 216A-1 generates a fixed operating frequency in the capture range of the system phase locked loops (PLL), 216A-2, 216B-1 and 216B-2.

The output signal of transmit OSC 216A-1 is converted to an optical synchronization (“sync”) signal S3 by optical transmitter 200A. Sync signal S3 is then coupled through circulator 204A, carried by fiber F1 to circulator 204B, where it is directed to and received by optical receiver 202B at Bob.

Control signals from Alice to Bob are extracted from the detected sync signal S3 of the optical receiver 202B and are synchronized to the receive time domain (RTD) of Bob.

The receive PLL 216B-2 and transmit PLL 216B-1 recover the signal from optical receiver 202B, and in effect make a locked copy of the RTD and transmit time domain (TTD) on Bob that is synchronized to the TTD on Alice.

The TTD on Bob is sent back to Alice via an optical sync signal S3′ generated by the optical transmitter 200B, which passes through circulator 204B, fiber F1, circulator 204A, and is received by optical receiver 202A.

The receive PLL 216A-2 at Alice recovers the corresponding electronic sync signal S4A generated by the received optical sync signal S3 at optical receiver 202A, so that the RTD on Alice is locked to the transmit timing domain (TTD) on Bob. Control signals from Bob to Alice are extracted from the output signal of the optical receiver 202A and are synchronized to the RTD on Alice. Explanation of the RTD and TTD follows in a later section.

B. Example Timing Operation of Two-Way Quantum Transceiver

FIG. 3B is a schematic diagram similar to FIG. 3A that illustrates another example embodiment of the timing system 70. FIG. 3B illustrates that a single topology that can be used to implement the circuits of Alice and Bob in FIG. 3A.

With reference to FIG. 3B, 216B-1 is now the transmit OSC that generates a fixed operating frequency in the capture range of all other system PLLs, 216A-1, 216A-2 and 216B-2.

The output of OSC 216B-1 is converted to sync signal S3 by optical transmitter 200B. Sync signal S3 is then coupled through circulator 204B, carried by fiber F1 to circulator 204A, and received by optical receiver 202A on Alice.

The receive PLL 216A-2 and transmit PLL 216A-1 recover (in electronic form) the optical sync signal S3 received by optical receiver 202A, and in effect make a locked copy of the RTD and TTD on Alice that is synchronized to the TTD on Bob.

The output of transmit PLL 216A-1 is converted by optical transmitter 200A to a corresponding sync signal S3, which passes through circulator 204A, to fiber F1, to circulator 204B, and is received by optical receiver 202B, which generates an electrical signal S4B corresponding to the received sync signal S3.

The receive PLL 216B-2 is locked to the output electrical signal S4B of optical receiver 202B so that the receive timing domain (RTD) on Bob is locked to the transmit timing domain (TTD) on Alice.

Control signals are extracted from the sync signal S3 outputted by optical receiver 202B already synchronized to the RTD on Alice.

Explanation of the usage of the RTD and TTD follows in a later section.

C. Example Timing Operation of OTDR

FIG. 3C is a close-up schematic diagram of a portion of timing system 70 as used in OTDR mode. With reference to FIG. 3C, fixed clock oscillator (OSC) 216B-1 generates a fixed operating frequency in the capture range of the other system PLL 216B-2.

The receive PLL 216B-2 locks to the signal from OSC 216B-1, allowing the controller to operate with the RTD and TTD acting as a single timing domain such that delay times between the events on the RTD and TTD can be measured. The measurement of delay times between pulses is then used to determine the position(s) of reflecting points RP1 in the link (e.g., fiber F1) connecting Bob to Alice.

D. Generalized Timing Circuit Operation

FIG. 3D is a close-up schematic diagram of a generalized example embodiment of Alice's portion of the timing system 70 as presented in FIGS. 3A-3C, but that includes more details of the PLLs therein. With reference to FIG. 3D, timing system 70 implements the timing functions for either Bob or Alice in the modes required in FIGS. 3A through 3C.

The timing system 70 of FIG. 3D includes a generalized optical receiver 202 (i.e., either optical receiver 200A or 200B), a phase comparator 600 coupled to the receiver a low pass filter (LPF) 602 coupled to the phase comparator, and voltage controlled oscillator (VCO) 604 coupled to LPF 602, that together comprise the PLL (e.g., Rx PLL 216A-2) for the receive timing domain (RTD). Likewise, a phase comparator 601, a low pass filter (LPF) 603 and voltage controlled oscillator (VCO) 605 together form the PLL (e.g., Tx PLL 216A-1) for the transmit timing domain (TTD).

RTD Operation

In operation, for the RTD, phase comparator 600 measures the phase difference between two clock signals from receiver 202 and produces a voltage proportional to the input phase difference. One the clock signal input is always in the RTD, the fed back output from the RTD VCO 604. The other clock signal can be selected by switch SW1 that connects phase comparator 600 to either optical receiver 202 at “A” or phase comparator 601 at “B” so that the phase comparator 600 measures the RTD clock versus the input from the optical receiver or measures the RTD clock versus the TTD clock.

LPF 602 shapes the output of the phase comparator 600 so that the PLL is stable from a feedback control system point of view, and so that high-order frequency content is removed from the input to the VCO 604.

VCO 604 is an oscillator producing an output clock with the frequency controlled by an input voltage control.

By feeding the output of VCO 604 back to the phase comparator 600, the input to the VCO 604 is adjusted by the LPF 602 to increase of decrease the output frequency of VCO 604 until the frequency and phase of the two inputs to the phase comparator are equal.

By changing the position of SW1 from position A to position B, the output of VCO 604 can be made to match the clock input from optical receiver 202 or VCO 605.

TTD Operation

For the TTD, phase comparator 601 measures the phase difference between two clock signals and produces a voltage proportional to the input phase difference. One clock signal input is always in the TTD, the fed back output from the TTD VCO 605. The other clock signal is always input from the optical receiver 202.

The Low Pass Filter 603 shapes the output of the phase comparator 601 so that the phase lock loop is stable from a feedback control system point of view, and so that high order frequency content is removed from the input to the VCO 605 through SW2.

VCO 605 is an oscillator producing an output clock with frequency controlled by an input voltage control.

When switch SW2 is in its A position, phase comparator 601, LPF 603 and VCO 605 form a phase locked loop, in a manner similar to that described above for the RTD. By feeding the output of VCO 605 back to the phase comparator 601, the input to the VCO 605 is adjusted by the LPF 603 to increase of decrease the output frequency of VCO 605 until the frequency and phase of the two inputs to the phase comparator are equal.

By changing the position of SW2 from its position A to its position B, the output of VCO 604 can be made to produce a fixed frequency output clock in the TTD that is the original timing clock that other PLL blocks must lock to.

Table 1 below shows the positions of switches SW1 and SW2 that allow the generalized circuit to perform necessary timing as shown in FIGS. 3A through 3C.

TABLE 1
Switch position for generalized timing circuit

| FIG. | Function | SW1 position | SW2 position |
|---|---|---|---|
| 3A | Alice | A | B |
| 3A | Bob | A | A |
| 3B | Alice | B | A |
| 3B | Bob | A | B |
| 3C | OTDR | B | B |

By changing the position of SW1 and SW2, all required timing generation can be performed by a single physical circuit realization.

III. FPGA-Based Controller Functions

A. Communication Between Bob and Alice

Timing synchronization must be performed not only to link the timing domains from transmitter to receiver, but to synchronize the frames of data so that both transmitter and receiver know they are operating on the same photon crossing the data communications channel even though the transmitter and receiver are not aware of the state of the receiver and transmitter on the other end of the transmission.

With reference again to FIG. 2C, a series of electrical synchronization (sync) pulses, collectively represented by electrical sync signal S4A-1, are created by the FPGA 132B in the controller 60B and communicated to optical transmitter 200B in optical model 50B. Optical transmitter 200B converts the electrical pulses to optical pulses, collectively represented by sync signal S3′, which pass through circulator 204B and through WDM 78B and travel over timing channel 54 (e.g., optical fiber F1). Sync signals S3′ are received at the corresponding optical receiver 202A in optical modem 50A.

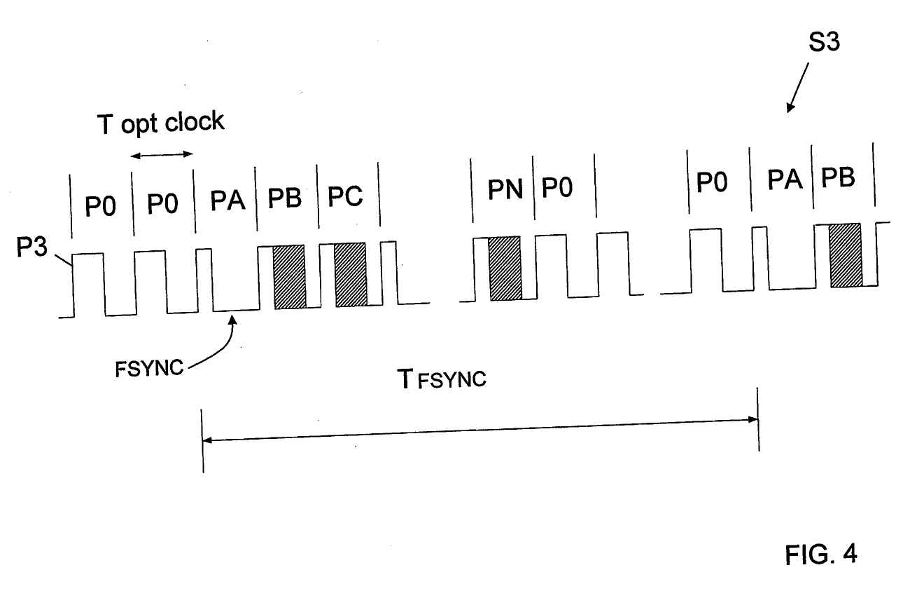

FIG. 4 shows the series of sync pulses P3 that make up optical sync signal S3. In an example embodiment, the leading edges of the pulses stay on a regular time interval Toclk nominally in the 10 ns to 50 ns range, while the width w of the pulses is used to encode data. An example of encoded data is where the pulse width that defines a logical 0 or 1 identifies the signal sender as Bob or Alice (i.e., authentication). Sufficient bandwidth is available to transmit the pulses of varying width such that the pulse width can be detected at the receiver.

In an example embodiment, sync signals S3 and S3′ are sent continuously, i.e., there is no interruption of the quantum signal S1 in order to send the sync signals. This optimizes the bandwidth of quantum channel 24.

The pulses P3 in sync signals S3 run continuously during operation at an optical clock period Toclk. Starting with the frame sync pulse PA, both controllers 60A and 60B co-ordinate their timing so they know they are operating on the same bit. Frame sync pulse PA can be repeated if necessary to ensure a unique pattern is recognizable at the receiver.

Following the frame pulses PA are multiple data pulses of arbitrary number, labeled PB through PN. Each pulse PB through PN can send frame synchronous data between receiver and transmitter parties on each link of the optical modem to help co-ordinate tasks such as declaring the state of each party.

Pulses with no meaningful data are labeled P0 and are inserted to fill the time between a subsequent frame sync pulse, again labeled PA.

The leading edge positions of the pulses are used by the phase comparators 600 and 601 in FIG. 3D. The data encoded in the pulse widths is encoded and inserted by FPGAs 132A and 132B. The time interval between frame sync pulses PA is given by T_{FSYNC}.

B. Pulse Timing Generation

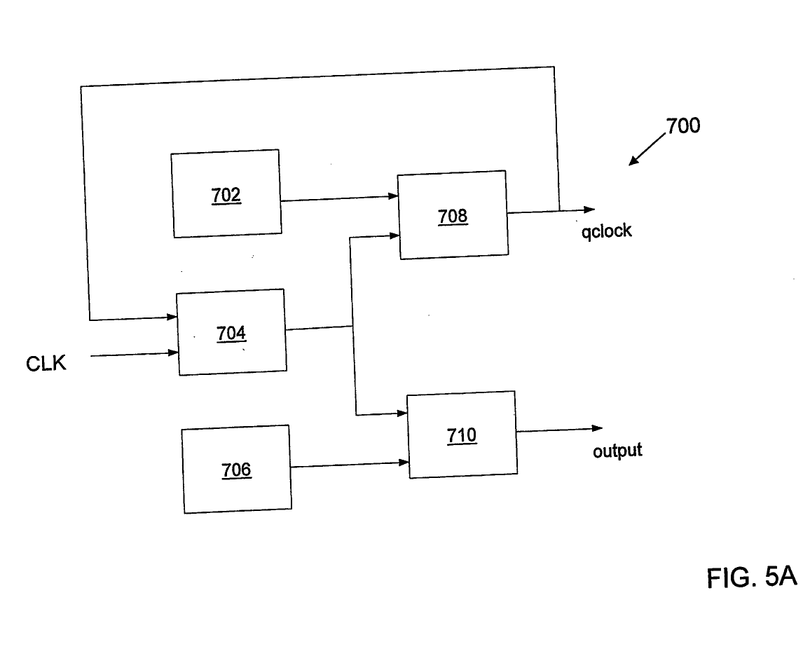

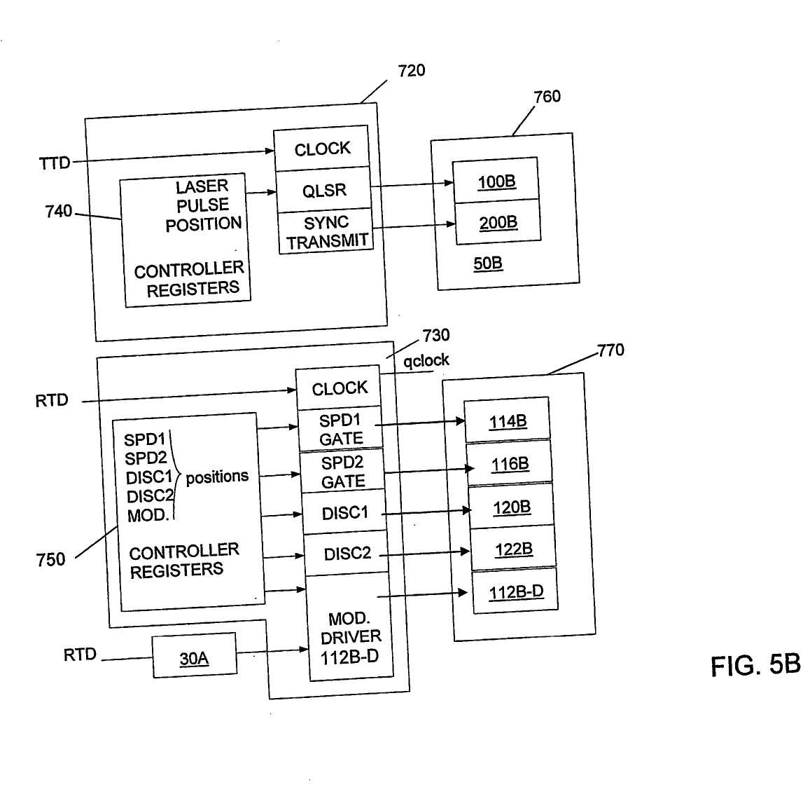

FIG. 5A is a schematic diagram of a clock-based digital pulse generator (DPG) 700 implemented in the FPGA as used to generate trigger pulses for the drivers. DPG 700 includes a counter 704 that increments on each positive edge of the input clock. The input clock is either a clock signal on the receive timing domain (RTD) or transmit timing domain (TTD).

DPG 700 also includes a digital comparator 708 that compares the value of counter 704 with a terminal count 702. When the terminal count is reached, the counter is reset to its initial state. The output of digital comparator 708 (qclock) pulses once every time a quantum pulse is transmitted over the QKD system (i.e., between Alice and Bob). Signal qclock is used below to trigger the operation of circuits that operate once per quantum pulse.

DPG 700 also include a digital comparator 710 that compares the value of the counter 704 with an FPGA register that determines the position at which an output pulse is generated.

With reference to FIG. 5B, the circuit of FIG. 5A is grouped and duplicated for each timing signal to be generated. Transmit timing machine (TTM) 720 groups all signals that are synchronized to the transmitted optical pulse on the quantum channel, and creates them at the same time with multiple copies of DPG 700. Only a single set of counter register 704, terminal count 702 and digital comparator 708 is required, and is shared by all members of DPG 700 in TTM 720.

Each output of TTM 720 has a separate register 706, grouped as control registers 740 and digital comparators inside TTM 720 to allow output pulses to be generated in different moments in time to drive external devices 760.

With continuing reference to FIG. 5B, the receive timing machine (RTM) 730, which has control registers 750, groups all signals that are synchronous to the received optical pulse on the quantum channel, and creates them at the same time with multiple copies of DPG 700. Only a single set of counter register 704, terminal count 702 and digital comparator 708 is required, and is shared by all members of DPG 700 in RTM 730.

Each output of RTM 730 has a separate register 706, grouped as control registers 750 and digital comparators 752 inside RTM 730 to allow output pulses to be generated in different moments in time to drive external devices 770.

External devices grouped in block 760 (e.g., laser 100B and optical transmitter 200B) can be dynamically changed depending on the system timing application. With reference also to FIG. 2C, laser 100B and optical transmitter 200B are both driven by the TTM, and are in the TTD. Single-photon detectors 114B and 116B, discriminators 120B and 122B, and modulator driver 112B-D, as external devices 770, are all driven by the RTM, and are in the RTD.

The selection of whether a driver should be in the TTD or RTD is determined by the timing compensation required. When the transmission time along optical path F1 is changed due to environmental factors, both the flight time of the signals on quantum channel 24 and timing channel 54 along the optical path F1 see the same environmental factors, and they change flight time by the same amount. Signals in the TTD do not get delayed as they do not travel along optical path F1. On the other hand, signals in the RTD are delayed by the optical path flight time. By using a separate RTD, the time variation in optical path flight time is automatically accounted for with reference also to FIG. 2E, for OTDR functions the RTD and TTD are locked together, so that the time delay of a pulse traveling from the TTD-based laser pulse 100B to the RTD-based photon detectors 114B and 116B can be measured. This allows the time variation in optical path flight time to be measured, rather than being removed. The time variation is then used to deduce information regarding the location reflection points RP1, which may be optical taps set up by an eavesdropper.

C. Random Number Generation and Insertion

With continuing reference to FIG. 5B, outputs 770 in the RTD are triggers for events that occur for every quantum pulse. For example, modulator driver 112B-D must be set to a different random value as part of the quantum key distribution process for every pulse that passes through modulator 112B.

At other times, such as when setting up and calibrating the QKD system, a consistent non-random value is applied to the modulator.

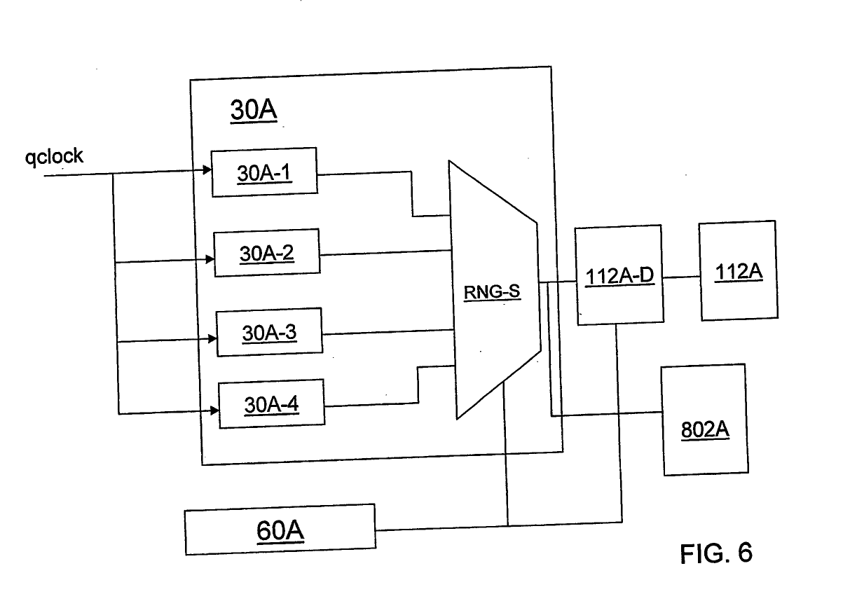

With reference now to FIG. 6, in an example embodiment RNG unit 30A includes a plurality (e.g., four) of individual data sources 30A-1 through 30A-4 that supply a new value at a low to high level transition of the qclock signal.

As an example embodiment, data source 30A-1 can be a hardware-based true random number generator, data source 30A-2 can be a linear shift register based pseudo random number generator, data source 30A-3 can be a fixed short length data output that produces non-random numbers, and data source 30A-4 can be an externally input data source. All data sources must update the values of their outputs during the low to high level transition of the qclock signal.

The example embodiment of RNG unit 30A of FIG. 6 includes a data source selector RNG-S that selects one of the plurality of data sources for presentation to modulator driver 112A-D. A copy of the data used to drive modulator 112A is buffered for later use to implement well-known QKD exchange mechanisms.

With reference again to FIG. 5A, DPG 700 controls when data from RNG-S is output by modulator driver 112A-D to drive modulator 112A, so that it is present on the modulator no longer than necessary to encode the photon passing therethrough.

D. External Peripheral Control

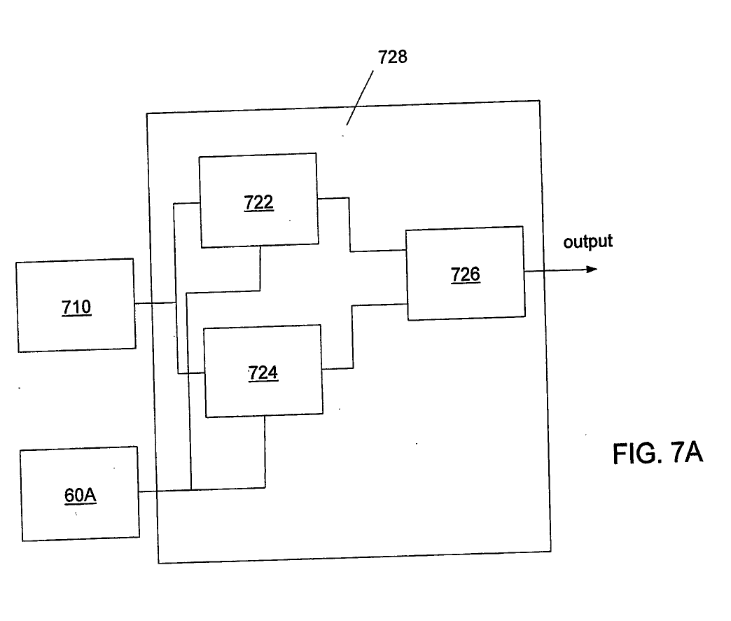

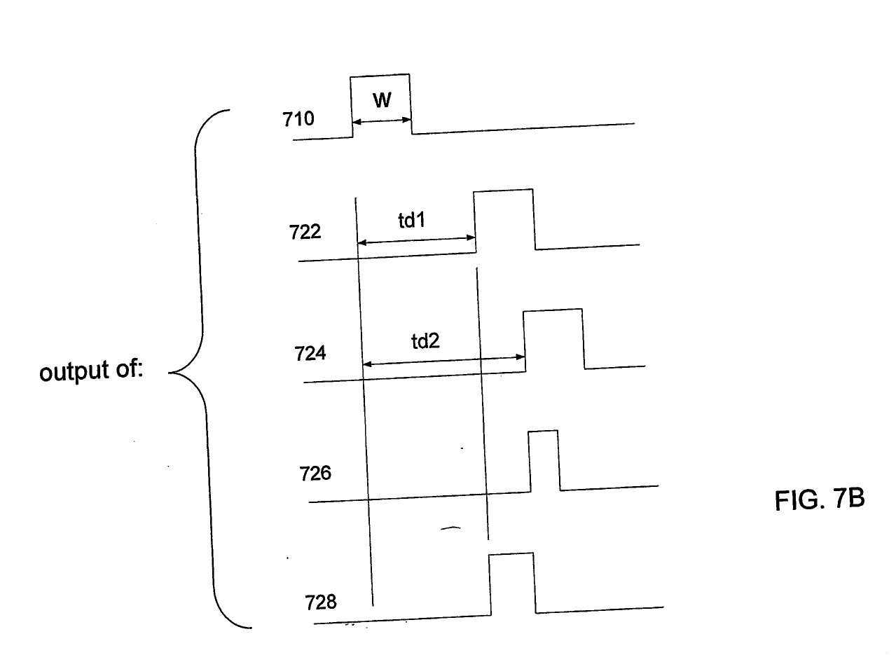

DPG 700 of FIG. 5A is limited in delay resolution based on the frequency of clock (CLK) input to counter 704, typically in the 100 MHz to 200 MHz range. With reference to FIG. 7A, a fine delay block 728 is placed after the output of each digital comparator 710 to allow the pulses outputted therefrom to be adjusted in finer steps, and to allow adjustment of output pulse width. In fine delay block 728, the output of digital comparator 710 is connected to delay blocks 722 and 724, each of which is connected to separate inputs of logic gate 726. The output of logic gate 726 is adjusted by the resolution of delay blocks 722 and 724.

Controller 60A is coupled to delay blocks 722 and 724 and programs them to set their delay. Typical delay blocks can delay inputs from 0 to 20 ns with better than 10 ps steps.

With reference now to FIG. 7B, digital output of block 710 shows an output pulse limited in time and width w to an interval of CLK input to block 704.

Output of delay 722 is delayed by interval td1 and output of delay 724 is delayed by interval td2. Logic gate 726 combines outputs of delay 722 and delay 724 to form a pulse with a start at td2 and an end at td1+w, with width td1−td2+w.

In an example embodiment, w is 8.00 ns, td1 is 5.72 ns and td2 is 8.40 ns. Output pulse of logic gate 726 is 8.40 ns after 5.32 ns, with adjustment capability of 10 ps of each edge.

Other logic in logic gate 726 can be used. Output 728 shows an alternative logic gate (A and (not B)) that results in an output pulse with start at td1 and end at td2. The pulse width is then td2 -td1, with no dependency on the variation of width w.

E. Single-Photon Data Collection and Processing

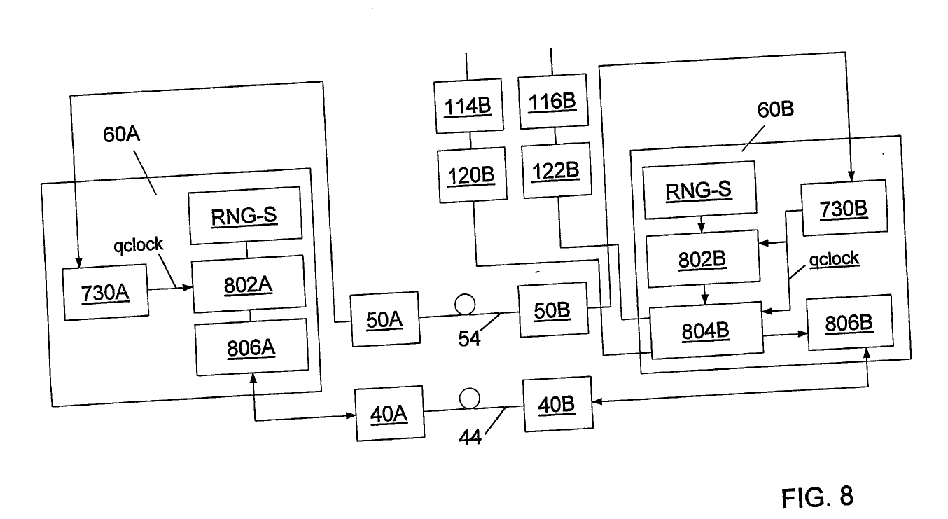

FIG. 8 is a schematic diagram of an example QKD system 800 of the present invention. In QKD system 800, RTM 730A and RTM 730B are synchronized as described above, and now the data transfer required to implement known QKD algorithms in QKD processors 806A and 806B needs to be carried out.

Frame sync pulses included in sync signals S3 sent between optical modems 50A and 50B over timing channel 54 ensure QKD engines 806A and 806B operate on data from the same photons as they pass through the QKD system.

Input data for processor 806A required to distribute quantum keys includes the state of phase or delay encoded on to single photons, as has been stored in RNG buffer 802A, and basis measurement information provided over public data channel 44 from QKD processor 806B.

Discriminators 120B and 122B indicate whether or not a single photon has been received by SPD 114B and SPD 116B in each of two orthogonal polarization. With each update from the qclock output of RTM 730B, the single-photon state is stored in SPD buffer 804B, and the modulator state is store in RNG buffer 802 in a synchronized fashion.

Input data for 806B required to distribute quantum keys includes the state of phase or delay encoded on to single photons from RNG buffer 802B, and results from SPD 114B and 116B from SPD buffer 804B. Basis measurement information is provided over public data channel 44 to QKD processor 806A.

What is claimed is:

1. A method of synchronizing the operation of first and second quantum key distribution (QKD) stations of a QKD system, comprising:
a) establishing in each QKD station respective receive and transmit time domains that are connected between the QKD stations via a timing channel;
b) transmitting from the first station to the second station quantum signals emitted by a laser source over a quantum channel connecting the first and second stations;
c) transmitting optical synchronization signals over a timing channel connecting the first and second QKD stations from respective optical transmitters and over the timing channel, without interrupting the transmission of the quantum signals;
d) forming the optical synchronization signal to include frame sync pulses and data pulses; and
e) coordinating transmission of the quantum signals, encoding of the quantum signals and detecting of the encoded quantum signals by locking the receive and time domains of the two QKD stations using the optical synchronization signals in order to establish a key between the two QKD stations.

2. A method according to claim 1, including multiplexing the quantum signals and sync signals onto a common transmission medium linking the first and second QKD stations.

3. The method of claim 1, wherein forming the optical sync signals includes:
a) generating an electrical sync signal from an FPGA; and
b) receiving the electrical sync signal at an optical transmitter; and
c) converting the electrical sync signal to the optical sync signal.

4. The method of claim 1, including sending the sync signals between a first optical modem in the first QKD station and a second optical modem in the second QKD station, wherein the first and second optical modems each have an optical transmitter and an optical transceiver coupled to a circulator, and wherein the circulators are connected to the timing channel.

5. The method of claim 4, including coordinating the operation of the optical transmitters and optical receivers in the first and second modems with first and second phase-lock loops (PLLS) in the first optical modem, and a third PLL and a transmit clock in the second optical modem.

6. The method of claim 1, wherein encoding the quantum signals includes:
a) generating random numbers from a random number generation unit having a plurality of data sources that generate data and that are coupled to a data source selector;
b) selecting one of the data sources using the data source selector; and
c) delivering the data from the selected data source to a modulator driver.

7. The method of claim 6, wherein a modulator is coupled to the modulator driver, and including:
a) providing a gating signal to the modulator driver that coordinates the activation of the modulator driver with the arrival of one of the quantum signals at the modulator based on the synchronization signals; and
b) encoding the quantum signal with the modulator.

8. The method of claim 1, wherein transmitting the quantum signals includes:
a) forming from the quantum signal first and second quantum pulses at the first QKD station and transmitting the quantum pulses over the quantum channel to the second QKD station;
b) at the second QKD station, randomly modulating one of the quantum pulses and attenuating the quantum pulses to form weak quantum pulses;
c) sending both pulses to back to the first QKD station via the quantum channel; and
d) randomly modulating the unmodulated pulse at the first QKD station.

9. The method of claim 1, wherein transmitting the quantum signals includes:
a) at the first QKD station, forming from each quantum signal first and second weak pulses, randomly modulating the first weak pulse and transmitting the modulated first weak pulse and the unmodulated second weak pulse over the quantum channel to the second QKD station; and
b) at the second QKD station, modulating the second weak pulse and combining the now-modulated first and second weak pulses.

10. The method of claim 1, including electronically adjusting the transmitting and receiving domains in each QKD station to compensate for time delays introduced in at least one of the quantum channel and timing channel.

11. A QKD system having first and second QKD stations, wherein each QKD station includes:
a) a quantum transceiver coupled to a quantum channel, the quantum transceiver having a modulator driver and a modulator, and adapted to transmit and/or receive quantum signals over the quantum channel;
b) a random number generator (RNG) unit coupled to the quantum transceivers, the RNG unit adapted to provide random numbers to the quantum transceiver so as to randomly encode a quantum signal passing through the modulator;
c) a public data transceiver (PDT) coupled to the RNG unit, the quantum transceiver and to a public channel;
d) an optical modem adapted to send and receive optical synchronization signals over a timing channel, the optical modem having an optical receiver and an optical transmitter both coupled to a circulator, which is coupled to the timing channel; and
e) a controller coupled to optics layer, the RNG unit and the optical modem, wherein the controller in one QKD station is adapted to synchronize the operation of the quantum transceiver and the RNG unit in the one station to the quantum transceiver and RNG unit of the other QKD station based on synchronization signals communicated between the controllers through respective optical modems via the timing channel without interrupting the transmitting and/or receiving of quantum signals over the quantum channel.

12. A timing system for a QKD system having first and second QKD stations each having a quantum transceiver, the system comprising:
a) an optical modem in each QKD station, wherein each optical modem has circulator coupled to a transmitter, a receiver, and a timing channel;
b) wherein one of the optical modems includes first and second phase lock loops (PLLs) coupled to the optical receiver and the optical transmitter located therein;
c) wherein the other optical modem includes a third PLL coupled to the optical receiver therein, and a clock coupled to the optical transmitter therein; and
d) a controller in each QKD station and coupled to the optical modem in the corresponding station, the controller being adapted to transmit and receive synchronization signals over the timing channel and through the optical modems to synchronize the operation of the quantum transceiver, wherein the synchronization signals include frame sync pulses and data pulses.

13. A QKD system comprising:
a) first and second QKD stations each having a quantum transceiver, a random number generator (RNG) unit, a public data transmission unit, an optical modem, and a controller, all operably interconnected within each QKD station;
b) a quantum channel connecting the quantum transceivers;
c) a public channel connecting the public data transmission units;
d) a timing channel connecting the optical modems; and
e) wherein the optical modems transmit and receive synchronization signals having frame sync pulses and data pulses that act to lock a receive time domain to a transmit time domain in each QKD station.

14. The QKD system of claim 13, wherein the timing channel and the public channel share a single physical connection between the two QKD stations.

15. The QKD system of claim 13, wherein the QKD system operates as a two-way system.

16. The QKD system of claim 13, wherein the QKD system operates as a one-way system.

17. The QKD system of claim 13, wherein one of the optical modems includes two phase lock loops and the other optical modem includes a phase lock loop and a clock that generates a synchronization signal.

18. The QKD system of claim 13, wherein synchronization of the QKD stations is controlled by the controller of either QKD station.
